(19) United States
(12) Patent Application Publication
(10) Pub. No.: US 2013/0095273 A1
(43) Pub. Date: Apr. 18, 2013

(54) Decorative and removable bannister, railing and spindle covers

(71) Applicant: Vincenzo Rinaudo, Livonia, NY (US)

(72) Inventor: Vincenzo Rinaudo, Livonia, NY (US)

(21) Appl. No.: 13/573,721

(22) Filed: Oct. 3, 2012

Related U.S. Application Data
(60) Provisional application No. 61/542,523, filed on Oct. 3, 2011.

(51) Int. Cl. G09F 7/18; G09F 3/10

(52) U.S. Cl. CPC G09F 7/18; G09F 3/10
USPC 428/43; 40/299.01; 428/174

(57) ABSTRACT

A decorative, removable cover for banisters, railing, spindles, and the like is made of a resilient material and includes a longitudinally extending opening allowing manual placement of the cover in covering relation over a respective banister, railing, spindle or the like. A plurality of covers may be provided in a kit which optionally includes a stencil and/or stickers having various decorative and/or text thereon allowing the consumer to customize the covers following purchase if desired.

### BACKGROUND OF THE INVENTION

The present invention relates to decorative covers for fencing, banisters, railings, spindles, and the like. A “banister” typically refers to the hand rail (also called a “balustrade”) which traverses and interconnects a plurality of upstanding, spaced spindles (also called “balusters”). The structure as a whole is sometimes referred to as a “railing”. “Fencing” typically denotes an outdoor structure having upstanding, spaced spindles with one or more horizontally extending cross-members interconnecting the spindles together. Regardless of the nomenclature used to describe a particular structure within this application, it is understood that the invention is usable with any one of the various structural elements described herein and regardless of whether the structure is intended for indoor or outside use.

Many homes and places of business include some type of fencing about porches, landscaping and other outdoor structures (e.g., pools, hot tubs, patios, gaming areas, gazebos, etc.). Stair railings are of course common within the interior of multi-level dwellings or outside multi-level decks. Railings and fencing come in a variety of architectural styles with spindles and banisters coming in a variety of cross-sectional shapes including round, oval, square, rectangular, etc. and may be uniform or vary in shape along the length of each spindle and/or banister. Railings and fencing may come in a variety of materials including wood, metal and vinyl, for example, which may be painted, stained or, as is common in the case of vinyl, left unpainted. Vinyl fencing has seen an increase in popularity in recent years due to its low maintenance requirements (i.e., durability and no need for yearly painting or sealing). There are presently little options for decorating such fencing other than to paint them different colors (e.g., applying murals) and/or draping decorative swags, garlands, wreaths and the like on the fencing. There therefore exists a need for other options for decorating fencing and railings.

### SUMMARY OF THE INVENTION

The present invention addresses the above need by providing removable decorative covers in the same general cross-section as the spindles and/or banister of a fencing or staircase railing structure. The covers may be made of any suitable material (e.g., a rigid yet bendable plastic).

### BRIEF DESCRIPTION FO THE DRAWING

FIG. 1 is a perspective view showing an embodiment of the invention with respect to a fencing structure;

FIG. 2 is a fragmented, plan view of a single cover of the embodiment of FIG. 1;

FIG. 3 is a fragmented, plan view showing another embodiment of the invention;

FIG. 4 is a fragmented, plan view showing yet another embodiment of the invention;

FIG. 5 is a cross-sectional view thereof as taken generally along the line 5-5 in FIG. 4;

FIG. 6 is a perspective view of the embodiment of FIG. 2;

FIG. 7 is a perspective view of the embodiment of FIG. 3;

FIG. 8 is a perspective view of the embodiment of FIG. 4;

FIG. 9 is a cross-sectional view of yet another embodiment of the invention;

FIG. 10 is a top perspective view of yet another embodiment of the invention;

FIG. 11 is a top perspective view of yet another embodiment of the invention;

FIG. 12 is a top perspective view of yet another embodiment of the invention; and

FIG. 13 is a cross-sectional view as taken along the line 13-13 in FIG. 12.

### DETAILED DESCRIPTION OF PREFERRED EMBODIMENTS

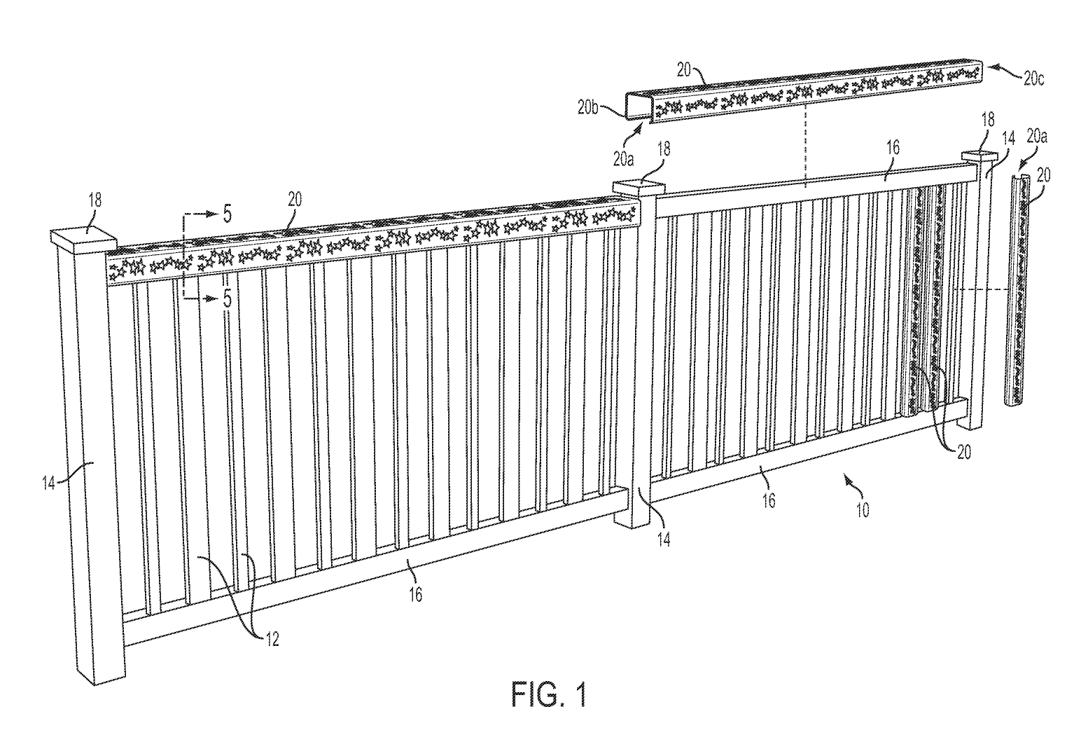

Referring now to the drawing figures, there is seen in FIG. 1 an exemplary fencing structure denoted generally by the reference numeral 10. Fencing 10 may include a plurality of upright, spaced spindles or slats 12 secured together by posts 14 and rails 16, for example. Posts 14 may include a top cap 18.

The present invention comprises one or more removable decorative covers 20 which may be positioned in covering relation over a respective spindle 12 and/or rail 20. More particularly, covers 20 are made of any suitable material but are preferably made of a material which is durable and bendable (e.g., a resilient plastic). As seen best in FIGS. 1 and 5, each cover 20 is provided with a longitudinally extending opening 20a which traverses the full length thereof between opposite open ends 20b and 20c such that one or both opposite panels 20e, 20f may be manually pulled apart (see curved arrow and panel 20f in dotted lines in FIG. 5) as it is placed around a respective spindle or rail 16. Upon release, panels 20e, 20f will return back to their normal position and generally conform in covering relation about the spindle and/or rail 16 as seen in FIGS. 1 and 5.

The width W₁ of longitudinal opening 20a may vary as desired. In the embodiment of FIG. 5, opening 20a width W₁ (as defined by the spacing between cover edges 20e′ and 20f′) is only slightly smaller than the width W₂ of the respective rail 16. This relatively large spacing width allows for easy attachment of cover 20 to rail 16, and also accommodates the spindles 12 where they attach to rail 16. Furthermore, the underside of rail 16 is not in normal view so it does not matter that there is no decorative covering on this side 16a of the rail 16. Regarding the spindles 12, the decorative panel located opposite opening 20a will face toward the direction in which the user would prefer (e.g., outwardly toward the location where people would be approaching the house). In other embodiments, the longitudinal opening 20a may have a medium or relatively small width which would allow those panels which define the opening to also have decoration applied for viewing if desired.

As seen in FIG. 9, one possible cross-section shape is cover 22 having panels 22a, 22b, 22c, 22d and 22e, one or more or all of which could have applied decoration thereto. Panel 22c is seen to be non-planar including opposite side panel portions 22C′ and 22c″. A longitudinal opening 22f allows for placement of cover 22 about a respective and cooperatively shaped spindle (not shown).

As seen in FIG. 13, yet another possible cross-sectional shape is cover 24 having panel sections 24a, 24b and 24c. A longitudinal opening 24d allows for placement of cover 24 about a respective and cooperatively shaped spindle (not shown).

It is noted that each cover 20 includes a cross-sectional shape that substantially conforms to the cross-sectional shape of the spindle and/or rail on which it is intended to be mounted. It is therefore contemplated that covers 20 may be offered in a variety of shapes and sizes, other than those shapes and sizes shown in the drawing figures, from which a consumer may choose to match the cross-sectional size and shape of the spindles and/or rails they wish to cover.

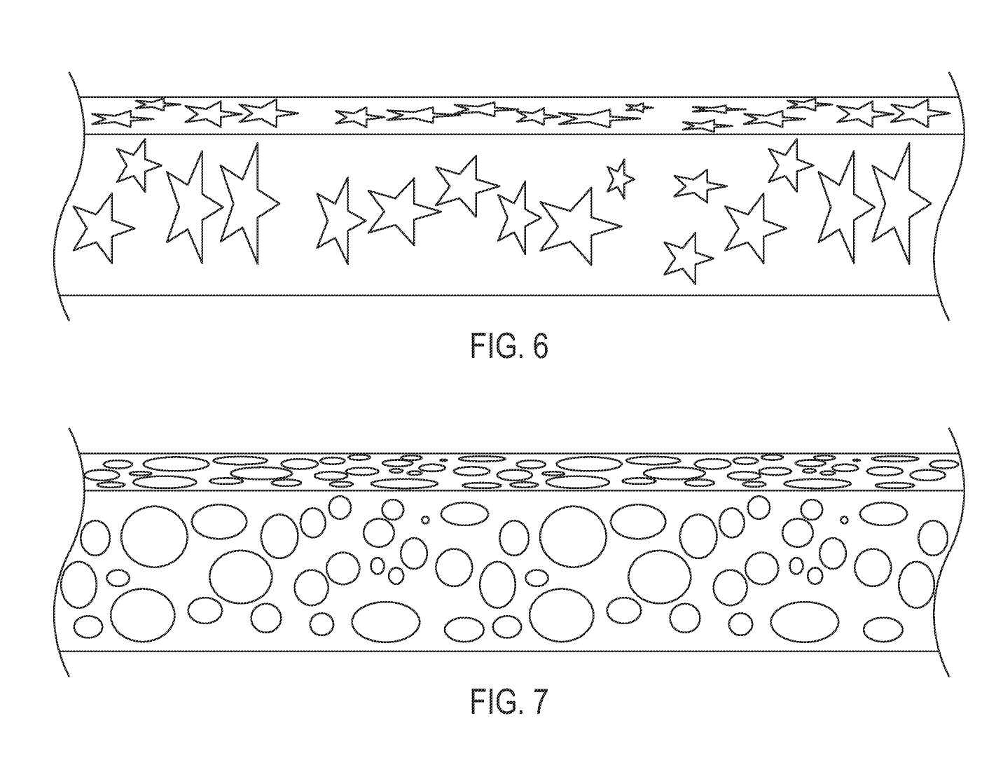

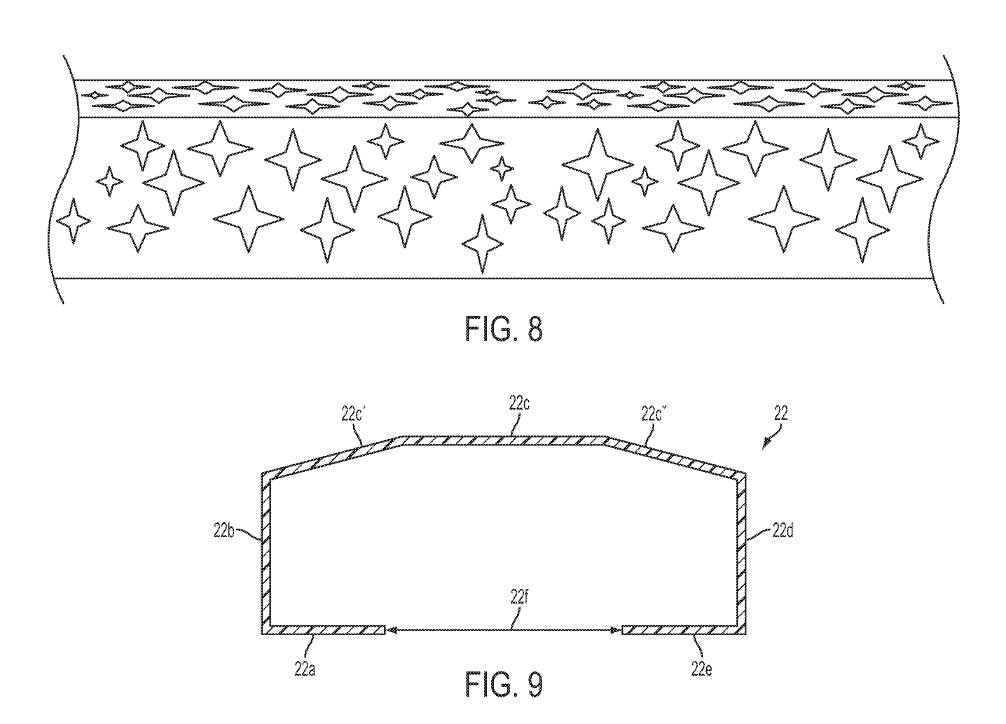

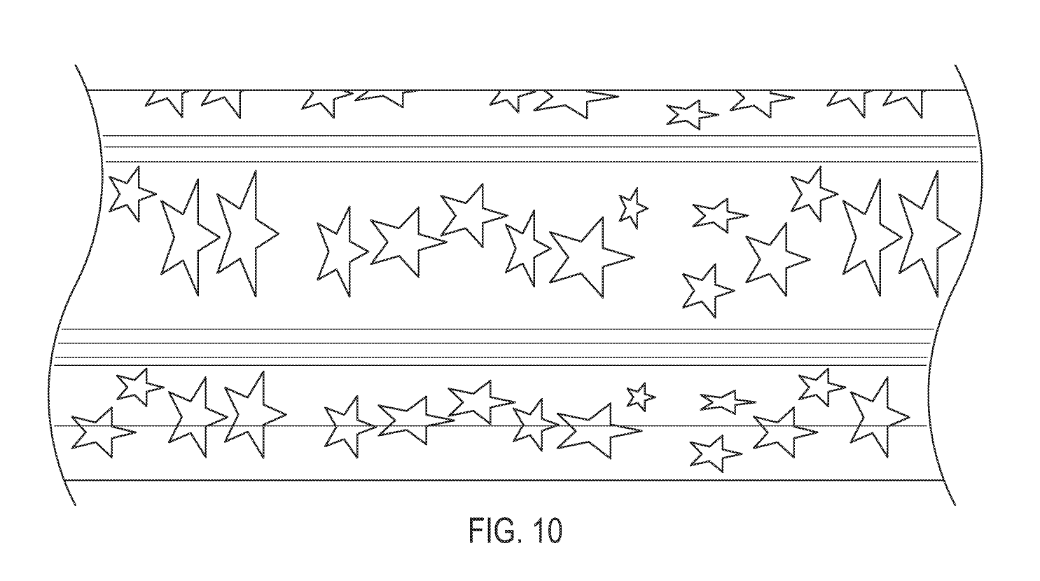

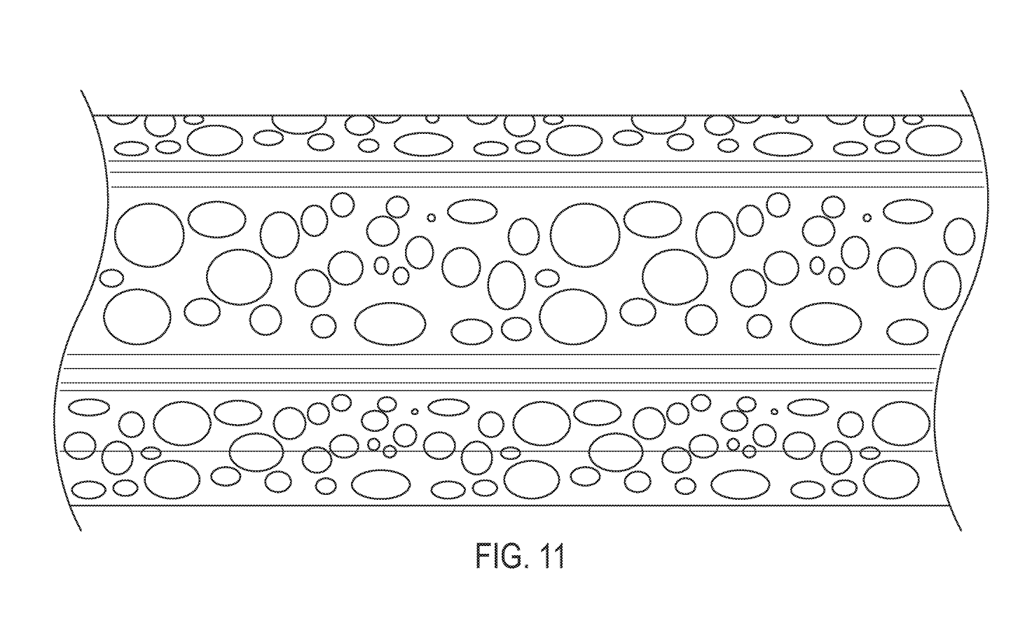

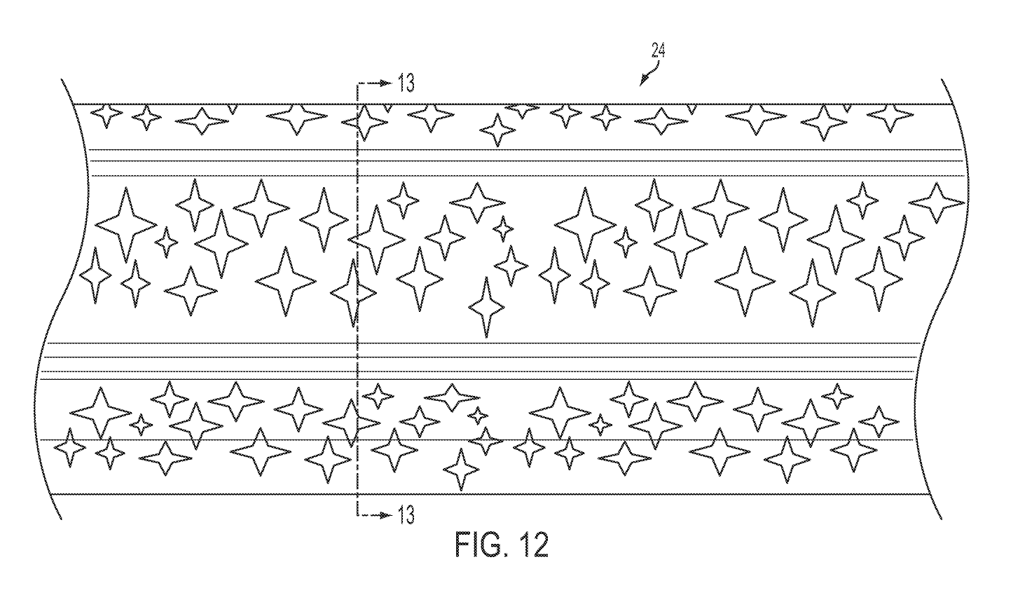

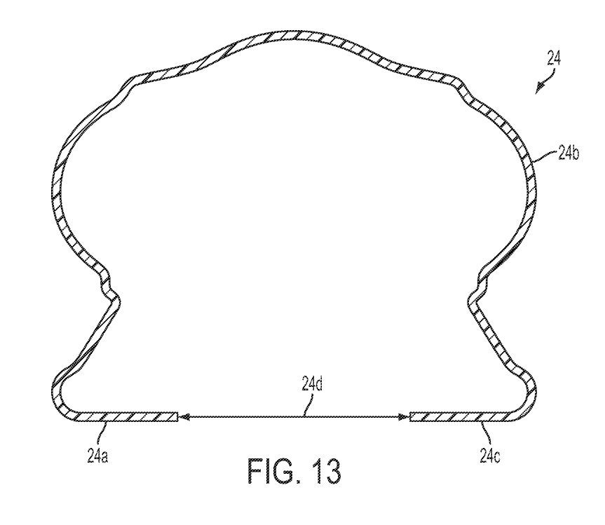

As seen in the various Figures, covers 20 may include ornamentation such as stars (FIGS. 1, 2, 4, 6, 8, 10 and 12), ovals, and circles (FIGS. 3, 7 and 11) although it is of course understood that the covers 20 may have any desired ornamentation (e.g., themed decorations for specific holidays).

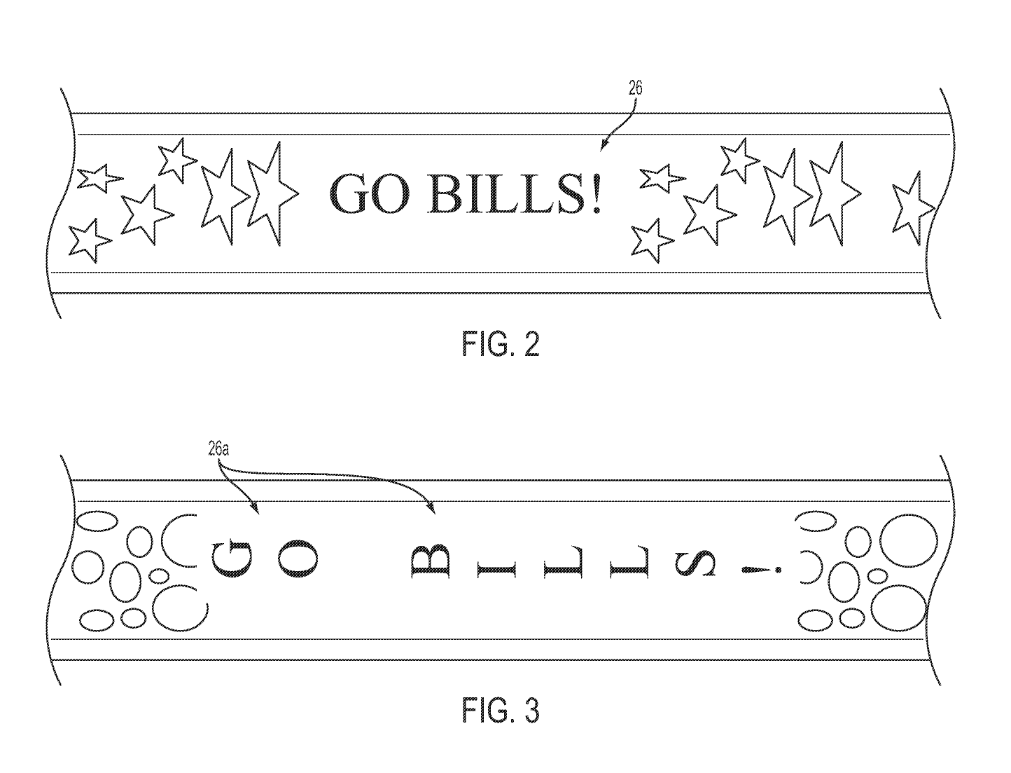

Text may also be included on covers 20 to indicate, for example, support for a favorite sports team (see FIGS. 2 and 3, for example), a person's birthday or other major life event (arrival of baby, anniversary, retirement, etc.). Text 26 may be provided on the covers 20 in normal left to right reading alignment for covers 20 intended to extend horizontally such as on a rail 16 (see FIG. 2), or text 26a may be provided in vertical top to bottom reading alignment for covers 20 intended to be attached to a spindle or slat 12 (see FIG. 3). The text 20,20a of course would be printed on one or more of the panels of cover 20 and preferably on the panel which faces toward the intended viewer. Text 20, 20a may be applied to a cover 20 in any known and desired manner, for example, screen-printing, stenciling, stickers, etc. In one embodiment of the invention, a kit comprising a plurality of covers 20 and a stencil kit and/or stickers may be provided whereby the consumer may then apply text of his or her own choosing to one or more covers 20.

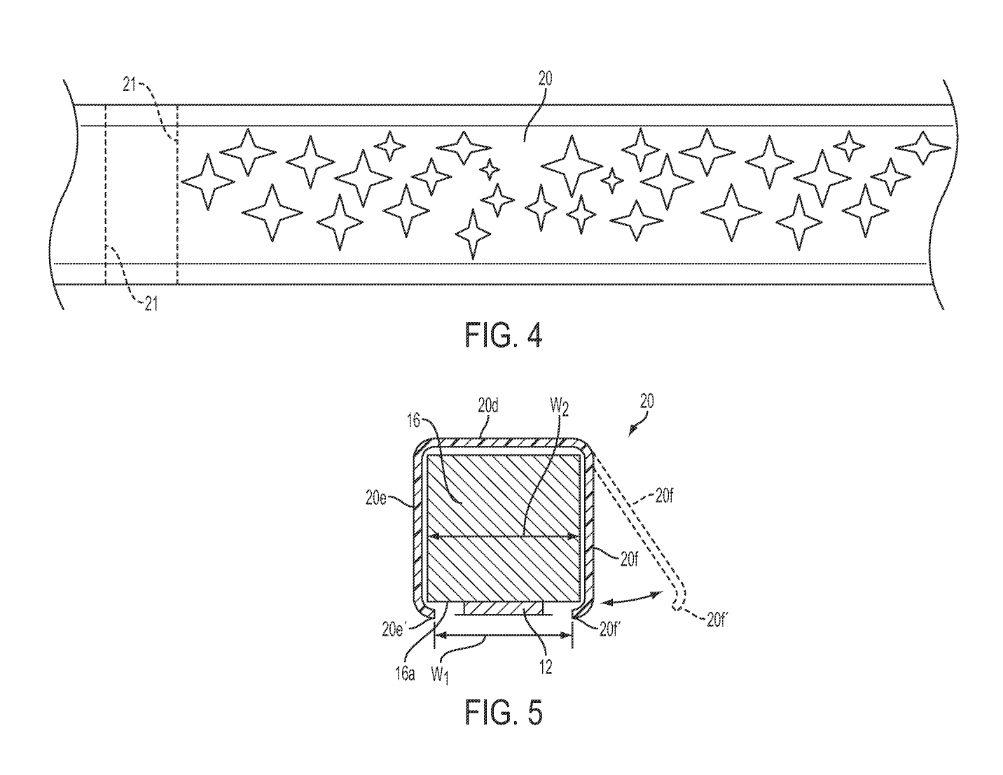

In yet another embodiment of the invention, one or more covers 20 may be provided with one or more tear lines 21 (FIG. 4) at spaced intervals which would allow the consumer to tear a cover 20 to the needed length.

While the invention has been shown and described herein with respect to particular embodiments thereof, it is understood that variations may be made without departing from the full spirit and scope of the invention which is defined by the claims which follow.

What is claimed is:

1. A removable, decorative cover for a banister, railing or spindle, said cover being formed of a resilient material having a length extending between first and second opposite, open ends and a longitudinal opening extending between said first and second open ends, said cover having a cross-sectional size and shape substantially identical to the corresponding cross-sectional size and shape of a respective banister, railing or spindle whereby said cover may be manually manipulated and positioned in covering relation over a respective banister, railing or spindle.

2. The cover of claim 1, and further comprising a decorative pattern applied to the surface of said cover which faces away from said banister, railing or spindle when in the attached condition.

3. The cover of claim 1, and further comprising text applied to the surface of said cover which faces away from said banister, railing or spindle when in the attached condition.

4. The cover of claim 1, and further comprising a kit containing a plurality of said covers.

5. The kit of claim 4, wherein said kit further contains a stencil for consumer application of designs and/or text to said covers.

6. The kit of claim 4, wherein said kit further contains stickers having decorations and/or text applied thereto, said stickers sized to allow consumer attachment to said covers.

7. The kit of claim 4, wherein one or more of said covers include one or more tear lines allowing the consumer to tear a portion of a cover away to shorten the length of said cover.

8. The kit of claim 5, wherein one or more of said covers include one or more tear lines allowing the consumer to tear a portion of a cover away to shorten the length of said cover.

9. The kit of claim 6, wherein one or more of said covers include one or more tear lines allowing the consumer to tear a portion of a cover away to shorten the length of said cover.
